(19) United States
(12) Patent Application Publication
(10) Pub. No.: US 2007/0233786 A1
(43) Pub. Date: Oct. 4, 2007

(54) Method and system for collaborative substitution on projects

(76) Inventor: Martina Rothley, Schwetzingen (DE)

Correspondence Address: KENYON & KENYON LLP, ONE BROADWAY, NEW YORK, NY, 10004, US

(21) Appl. No.: 11/396,392

(22) Filed: Mar. 31, 2006

(51) Int. Cl. G06F 15/16

(52) U.S. Cl. 709/204

(57) ABSTRACT

A method and system are provided for collaborative information sharing to facilitate the substitution of individuals working on a project or at a task by linking documents in a business information system with office products, such as for example a shared appointment calendar application. The collaborative information sharing functionality provides links in the office products to the documents providing the appropriate detailed or background information. The office products provide the scheduling for the tasks while the business information system stores the documents providing the detailed information. The collaborative information sharing functionality may provide an additional notes and attachments screen in the business information system to track and manage the documents linked to the office products. For example, a link placed in the notes of appointment in a shared calendar system may link to a document listed in the notes and attachments screen of the business information system.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system for the collaborative substitution of colleagues on a project using linked task data according to one embodiment of the present invention.

### BACKGROUND

Projects and work groups in companies typically involve multiple individuals each responsible for separate tasks such as meetings, deliverables, documentation, etc. When a colleague is not available for whatever reason (e.g., medical leave) the process of covering for the tasks of the absent colleague may be difficult to implement because of the lack of familiarity with the details of the colleagues tasks and the information flow to the person substituting for the absent colleague may be incomplete. Widely used programs such as appointment calendars let others know about scheduled meetings but still do not fully facilitate the substitution of colleagues under these circumstances.

The present invention implements an innovative method for addressing this problem by providing for collaborative substitution by linking documents providing the necessary background information with office products such as the appointments or meeting requests in a shared appointment calendar application.

### BRIEF DESCRIPTION OF THE DRAWINGS

FIG. 1 is a diagram illustrating the network environment in which the collaborative information sharing functionality is provided according to one embodiment of the present invention.

FIG. 2 is a flowchart of a collaborative information sharing process using an office product such as a shared calendar according to one embodiment of the present invention.

FIG. 3 is an example of a displayed screen for a business information system containing purchase order and other data using the collaborative information sharing functionality according to one embodiment of the present invention.

FIG. 4 is an example of a displayed screen for a business information system containing the work inbox for a work group or team colleague using the collaborative information sharing functionality according to one embodiment of the present invention.

FIG. 5 is an example of a screen from a shared calendar office product used to schedule appointments using the collaborative information sharing functionality according to one embodiment of the present invention.

FIG. 6 is an example of a displayed screen for a business information system containing the linked documents for the scheduled event using the collaborative information sharing functionality according to one embodiment of the present invention.

FIG. 7 is an example of document opened and displayed from within the notes and attachments screen (the document listing screen) of the business information system implementing collaborative information sharing functionality according to one embodiment of the present invention.

FIG. 8 is a block diagram illustrating the platform on which the collaborative information sharing functionality may operate according to one embodiment of the present invention.

### DETAILED DESCRIPTION

A method and system are provided for collaborative information sharing to facilitate the substitution of individuals working on a project or at a task by linking documents in a business information system with office products, such as for example a shared appointment calendar application, according to one embodiment of the present invention. The collaborative information sharing functionality provides links in the office products to the documents providing the appropriate detailed or background information. The office products provide the scheduling for the tasks while the business information system stores the documents providing the detailed information according to this embodiment. The collaborative information sharing functionality may provide an additional notes and attachments screen in the business information system to track and manage the documents linked to the office products. For example, a link placed in the notes of appointment in a shared calendar system may link to a document listed in the notes and attachments screen of the business information system according to this embodiment.

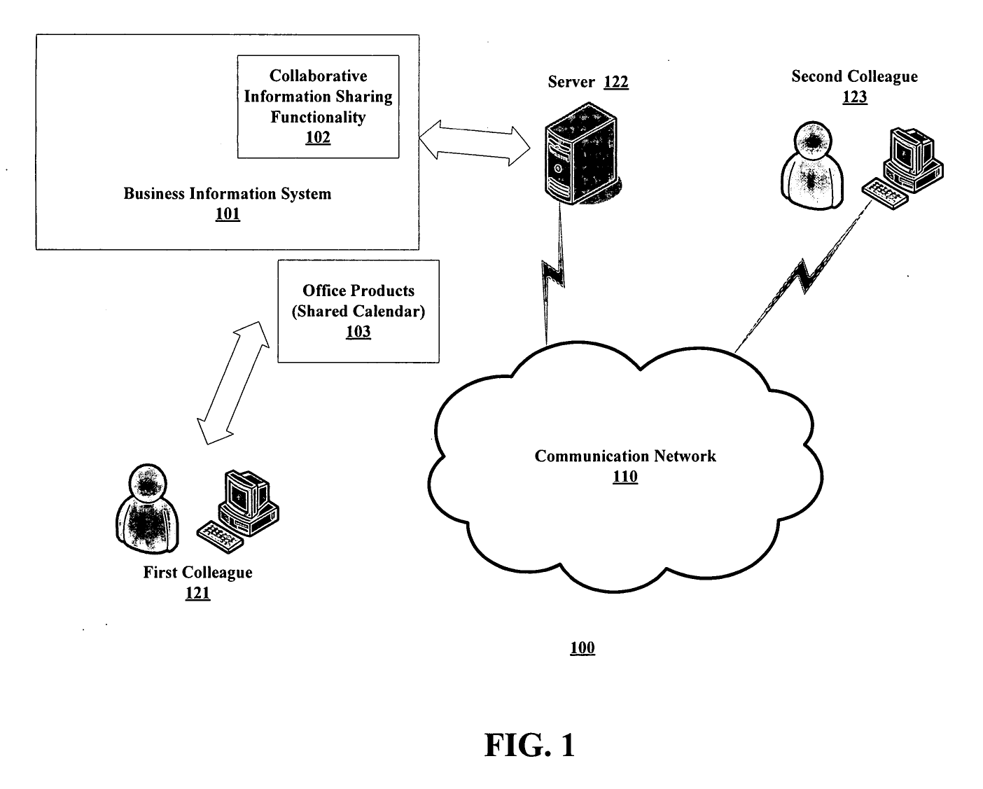

FIG. 1 is a diagram illustrating the network environment in which the collaborative information sharing functionality is provided according to one embodiment of the present invention. The collaborative information sharing functionality 102 may consist of one or more software applications, programs, modules, procedures, or other computer code to include firmware and may additionally include stored data that may be part of the business information system 101 (e.g., a purchase order system) it works with (shown) or it may be external to the business information system 101 (not shown) where it provides specific collaborative information sharing functionality according to alternative embodiments of the present invention. The office products 103 may also be part of the business information system 101 (not shown) or the office products 103 may be separate (shown). The office products may include shared time management applications such as a shared calendar and/or meeting request system. In the embodiment shown in FIG. 1, the collaborative information sharing functionality is part of the business information system 101 which may reside on a corporate server 122. In other embodiments, the business information system 101 and/or the collaborative information sharing functionality 102 may reside on one or more servers, computers, or other hardware platforms of the application environment 100. The server 122 may be connected to a colleague 121 over an internal or external communication network (not shown) such as, for example, a local area network (LAN). The business information system 101, one colleague 121, and server 122 may also be linked to another colleague 123 over an external communication network 110 such as for example the Internet. In the embodiment shown, a first colleague 121 using the business information system 101 is connected to the communication network 110 and a second colleague 123 through the server 122. The application environment 100 shown is only one possible implementation of the collaborative information sharing functionality 102.

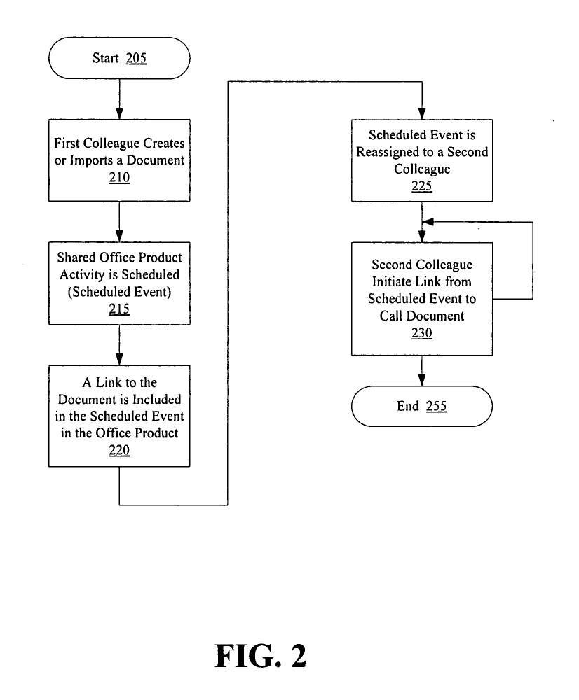

FIG. 2 is a flowchart of a collaborative information sharing process using an office product such as a shared calendar according to one embodiment of the present invention. The process begins 205 in a first step 210 where a first colleague creates or imports a document in the business information system containing detailed information relating to a meeting, task, project, or other activity. The document is the first colleague's information or notes relating to activity. Though documents providing notes for a project may be used in other applications, these note documents or attachments are part of the business information system and separate from the office products to which they will be linked. In addition the documents may be stored and tracked as a specially category of documents allowing all the colleagues to review the existing documents in the business information system. In one embodiment of the present invention, the documents themselves may be collaborative documents where the more than one colleague may contribute to creating, updating, and maintaining the document. In an alternative embodiment, the document may be created by a single work colleague and may not be updated or otherwise changed by other colleagues in order to preserve the creating colleague's notes regarding the task or activity. These documents may also include documents generated for other purposes but now used for the collaborative information sharing functionality. For example, a document reporting on quality problem regarding a supplier's deliveries may be generated as part of the inventory or purchase order systems of a company but may also be used in the collaborative information sharing functionality of this embodiment of the present invention. These examples are illustrative of some of the possibilities regarding the documents in the business information system according to this embodiment of the present invention.

In a second step 215, a task, appointment, meeting, or other entry (i.e., a scheduled event) is made in a shared office product such as a shared calendar application. The office product may be a commonly used product or its functionality may be widely used. The office product may serve as the scheduling tool according to this embodiment where the office product provides a time context to the information in the document. For example, a document reporting quality problems regarding a supplier's deliveries may be stored in the business information system as discussed above along with numerous other documents. If an appointment is scheduled in a shared calendar office product with the supplier to discuss the quality problems with that supplier's deliveries, the appointment creates a context in time (a relevant time period) in which that document may be particularly important to another colleague on the team substituting for the primary or first colleague normally responsible for this task.

In a third step 220, a link to the document created or imported in the first step 210 is included in the scheduled event made in the office product during the second step 215. The link may be included in any appropriate place permitted by the office product. For example if the office product is a shared calendar application, the link may be included in the notes or remarks section of a scheduled meeting or appointment. In other office products or for other events, the link may be stored in other appropriate areas of the scheduled event. The link may be considered a software call to the document. For example, the link may contain navigation information initiating the opening of the document which may also include the launching of the business information system in which the documents is opened. The document may also open separately from the business information and the link will open the document accordingly. The link itself may be inactive until activated by a user such as for example clicking a pointing device on the link.

In a fourth step 225, the scheduled event is reassigned to a second colleague instead of the primary colleague. In this step, another colleague takes over the scheduled event for which the first colleague is primarily responsible or for which the first colleague is more knowledgeable. Under these circumstances, the collaborative information sharing functionality according to this embodiment of the present invention provides the second colleague the ability to quickly and efficiently come up to speed on the scheduled event and to easily and quickly have any necessary documentation available. In other embodiments, the second colleague may take over the scheduled event for any number or reasons or may be assisting the first colleague with the scheduled event.

In a fifth step 230, the second colleague initiates the link in the scheduled event of the office product and retrieves the associated documentation providing the second colleague a quick and efficient means for substituting in place of the first principal colleague. In this manner, colleagues in work group or team may cover and take over scheduled events for each other with minimal interruption to work group or team efficiency. The process may then be repeated or it concludes 235 for the scheduled event.

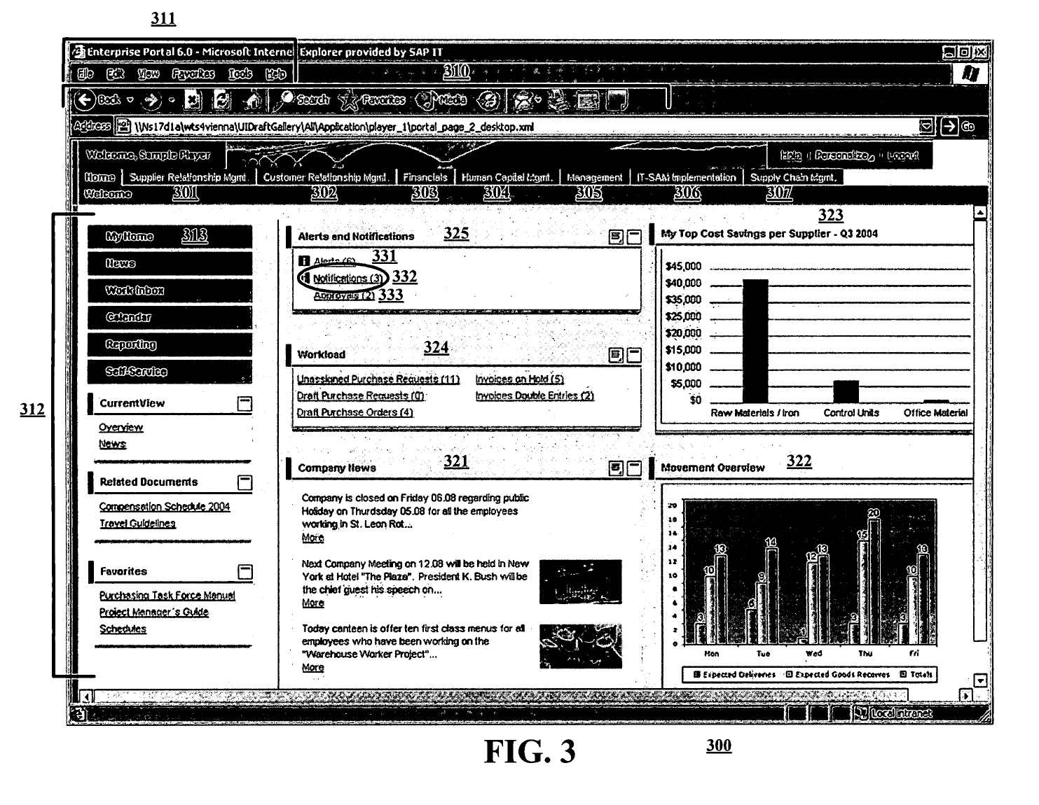

FIG. 3 is an example of a displayed screen for a business information system containing purchase order and other data using the collaborative information sharing functionality according to one embodiment of the present invention. The example business information system screen 300 is displayed in a web browser using known web browser navigation elements 310 and menus 311. In addition to the standard web browser elements 310-311 on the screen 300, information system specific navigation such as a horizontal row of navigation tabs 301-307 and a left-side pane containing navigation shortcuts 312 are also shown. The displayed screen 300 shows the contents of a customizable homepage which is indicated by the highlighted “My Home” navigation shortcut 313 on the left-side pane 312. The homepage shown in this example embodiment provides a summary of company news 321, a product movement graph 322, a cost savings graph 323, a workload summary 324, and an alerts and notifications summary 325. The alerts and notifications summary 325 displays the number of alerts 331, notifications 332, and approvals 333 for the purchaser. For example, there are currently three (3) notifications 332 available for the colleague. The colleague may click on the notifications link 332 to navigate directly to these notifications. These notifications may include a request to reassign or reassignment of a scheduled event from a first primary colleague to a second colleague.

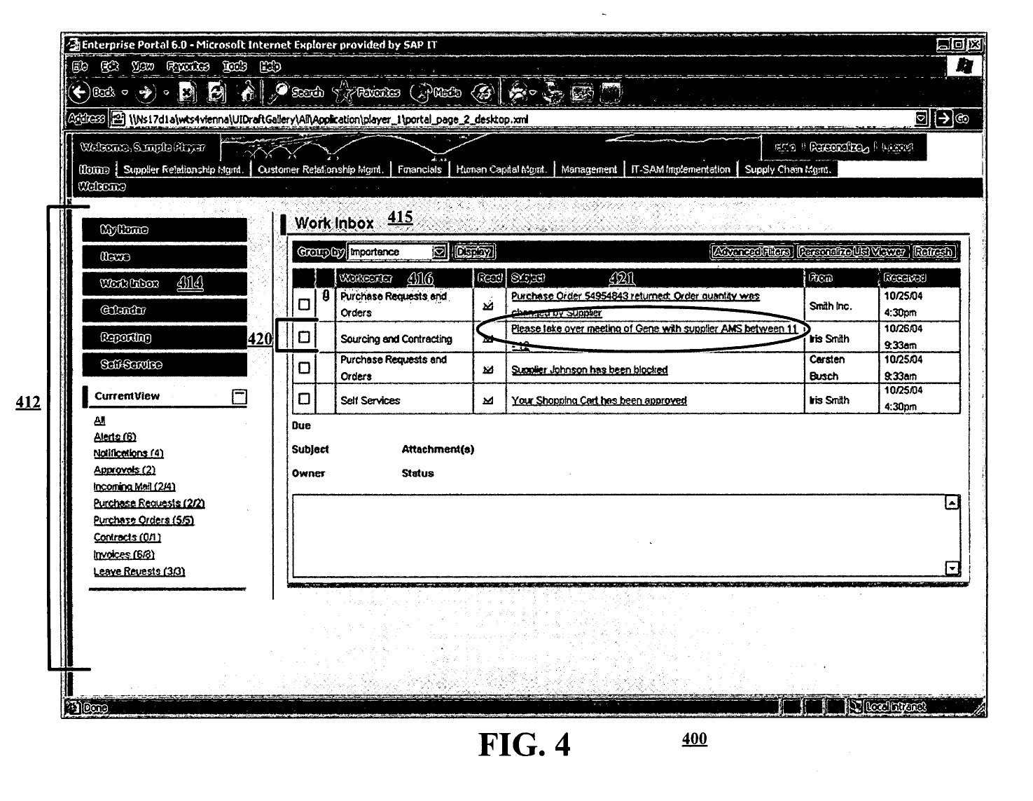

FIG. 4 is an example of a displayed screen for a business information system containing the work inbox for a work group or team colleague using the collaborative information sharing functionality according to one embodiment of the present invention. The displayed screen 400 shows the work inbox which is indicated by the highlighted “Work Inbox” navigation shortcut 414 on the left-side pane 412 and the “Work Inbox” title 415 on the screen 400. The work inbox may include many types of messages belonging to different work centers 416, representing a category to which the message applies, such as for example “Sourcing and Contracting”. The messages shown in the work inbox are new messages that have not yet been viewed and/or acted upon according to this embodiment. In the example shown in FIG. 4, the second message 420 is a request to reassign a scheduled event from a first primary work group or team colleague to a second colleague. The subject heading 421 for the second message 420 indicates that the request to the second colleague is to take over a meeting with a supplier “AMS” in place of the first primary colleague “Gene”. The work inbox screen 400 allows a work group or team colleague to view a summary of information from which he/she may then examine details as they feel necessary. If the colleague clicks on the message link in the subject column of the message, the colleague will be presented (navigated to) the details of the message.

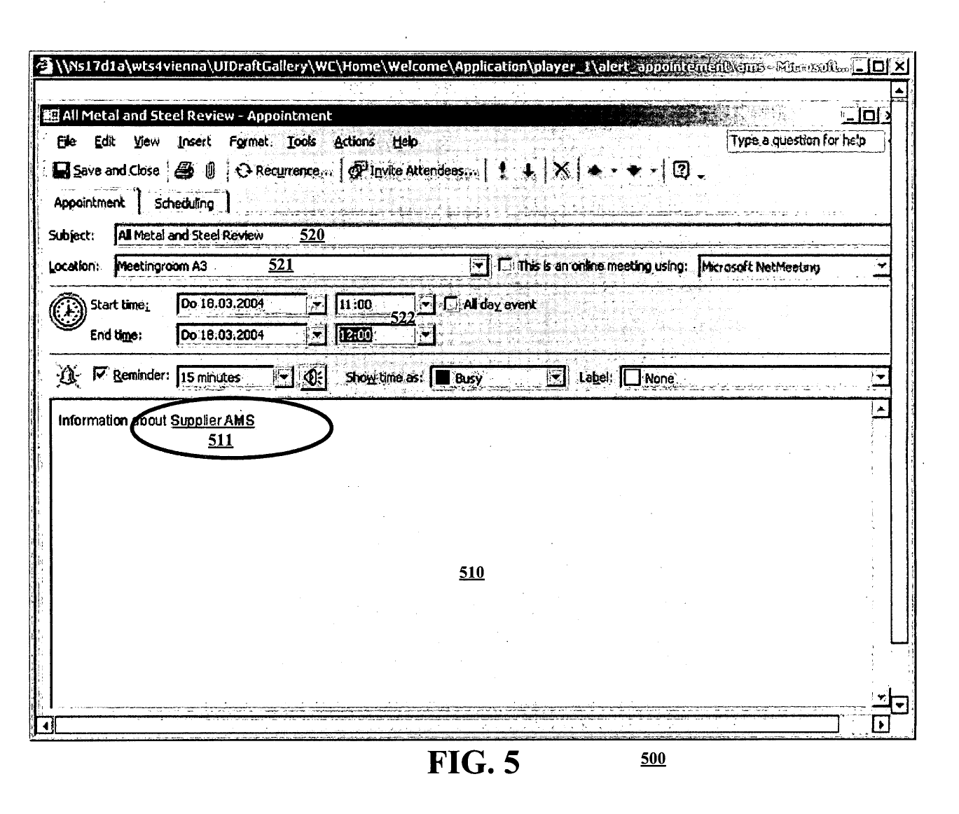

FIG. 5 is an example of a screen from a shared calendar office product used to schedule appointments using the collaborative information sharing functionality according to one embodiment of the present invention. The shared calendar application screen 500 shows an already scheduled appointment. The subject of the meeting 520 and location 521 are shown along with the meeting time 523 and notes 510. In the notes, a link 511 is provided allowing a colleague viewing the appointment in the shared calendar application to retrieve information provided with the link 511. Though a single link 511 is provided in the example shown in FIG. 5, multiple links may be provided in another embodiment of the present invention. In this example embodiment, the link 511 contains information regarding the supplier “AMS” as is indicated the text of the link 511.

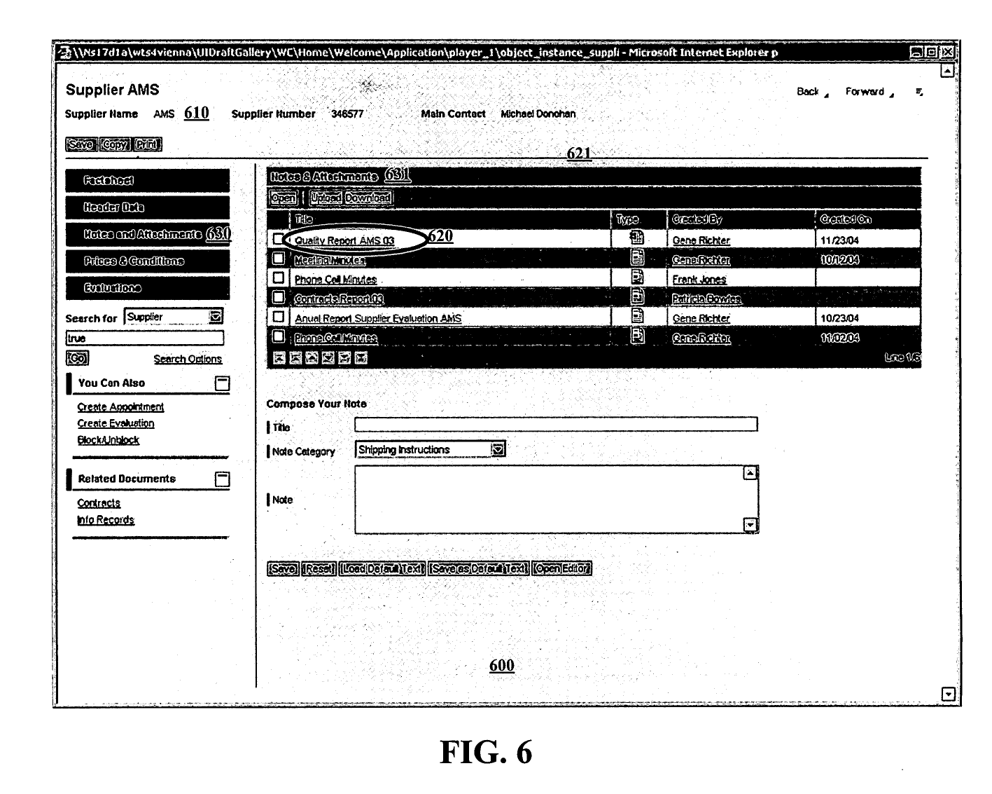

FIG. 6 is an example of a displayed screen for a business information system containing the linked documents for the scheduled event using the collaborative information sharing functionality according to one embodiment of the present invention. The displayed screen 600 contains a listing (i.e., a table) 621 of the documents linked to the scheduled event by the primary colleague to provide additional information and background for the scheduled event. In this example screen 600, information is provided for the supplier “AMS” 610 as indicated in FIG. 5 in the link within the scheduled event. The notes and attachments 630 information is indicated by the highlighted notes and attachments navigation shortcut on the left-side pane in the screen 600 as well as by the title 631 in the document listing 621. The first document 620 in the listing 621 may be of particular importance as it relates to a quality report for the supplier 610 and is the subject of the meeting (i.e., the scheduled event) in this example embodiment. Clicking on an entry in the document listing 621 may result in the document contents being opened and presented to the user according to this embodiment.

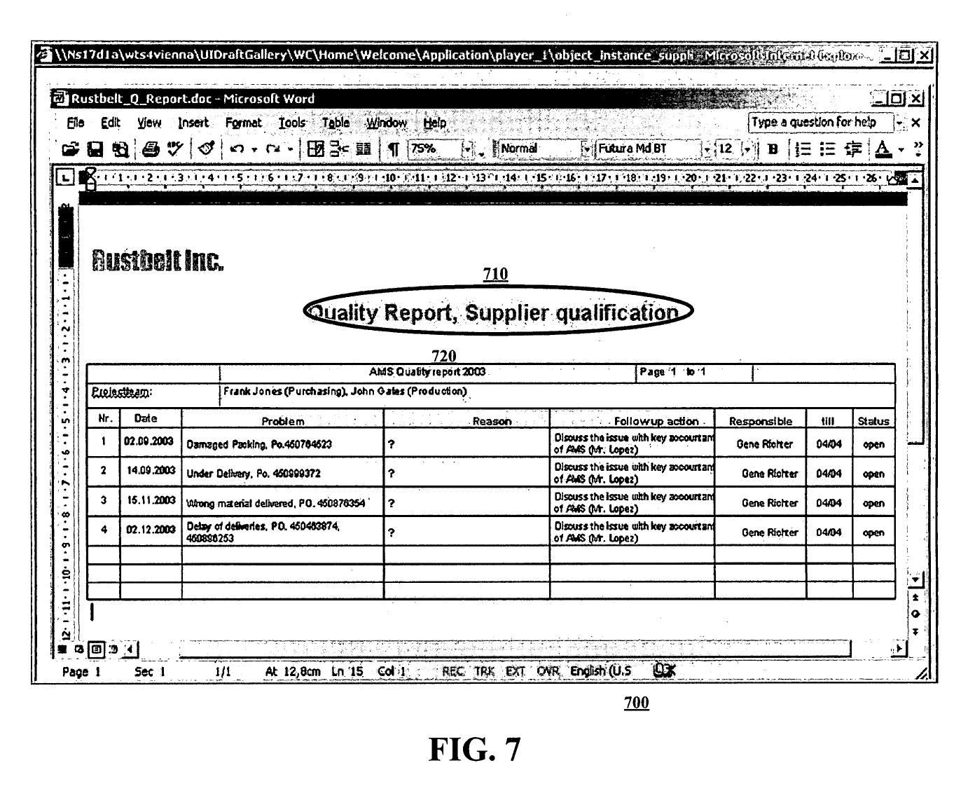

FIG. 7 is an example of document opened and displayed from within the notes and attachments screen (the document listing screen) of the business information system implementing collaborative information sharing functionality according to one embodiment of the present invention. The document 700, in this case a quality report on the supplier as indicated by the title 710, contains a table 720 of quality issues relating to the supplier. This is the type of information that will allow a colleague less familiar or unfamiliar with the supplier to come up to speed quickly for a meeting and to be prepared efficiently and quickly.

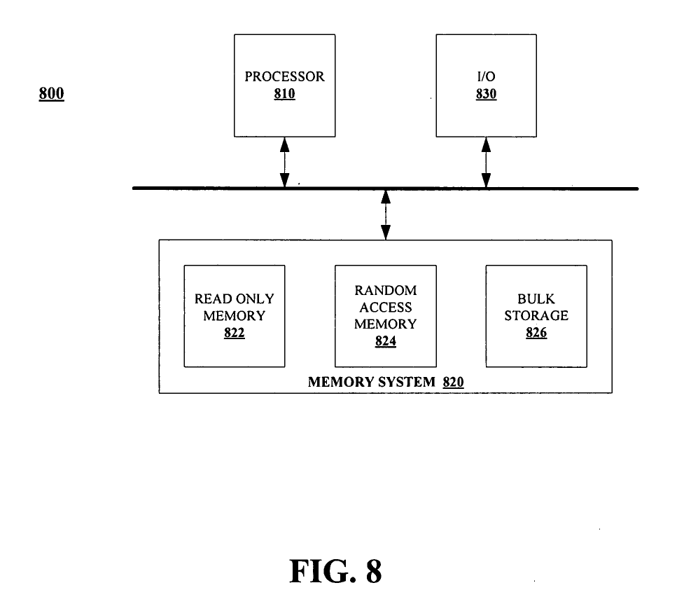

FIG. 8 is a block diagram illustrating the platform on which the collaborative information sharing functionality may operate according to one embodiment of the present invention. Functionality of the foregoing embodiments may be provided on various computer platforms executing program instructions. One such platform 800 is illustrated in the simplified block diagram of FIG. 8. There, the platform 800 is shown as being populated by a processor 810, a memory system 820 and an input/output (I/O) unit 830. The processor 810 may be any of a plurality of conventional processing systems, including microprocessors, digital signal processors and field programmable logic arrays. In some applications, it may be advantageous to provide multiple processors (not shown) in the platform 800. The processor(s) 810 execute program instructions stored in the memory system. The memory system 820 may include any combination of conventional memory circuits, including electrical, magnetic or optical memory systems. As shown in FIG. 8, the memory system may include read only memories 822, random access memories 824 and bulk storage 826. The memory system not only stores the program instructions representing the various methods described herein but also can store the data items on which these methods operate. The I/O unit 830 would permit communication with external devices (not shown).

In other embodiments of the present invention, the collaborative information sharing functionality may be applied in other contexts such as for example in project management and product development. In these other examples, the collaborative information sharing functionality can identify and simple the management of large quantities of information.

What is claimed is:

1. A method for providing a collaborative information environment linking a document in a business information system with a scheduled event in an office product, comprising:
generating the document in the business information system, wherein the document contains specific information relevant to an activity of a first colleague;
creating the scheduled event for the first colleague in the office product, wherein the scheduled event is a function of the activity of the first colleague;
including a link in the scheduled event for the first colleague, wherein the link is a software call to the document in the business information system;
assigning the scheduled event to a second colleague; and
providing the document to the second colleague as a function of the assigned scheduled event and the included link.

2. The method according to claim 1, wherein the scheduled event is a meeting request.

3. The method according to claim 1, wherein the scheduled event is an appointment.

4. The method according to claim 1, wherein the office product is a shared calendar application.

5. The method according to claim 1, wherein the office product is at least one of a meeting request application and a shared appointment application.

6. The method according to claim 1, the generating step further comprising:
importing the document into the business information system, wherein the document contains specific information relevant to an activity of a first colleague and the document is already created using a separate application.

7. The method according to claim 1, the generating step further comprising:
creating the document in the business information system, wherein the document contains specific information relevant to an activity of a first colleague and the document is created by the first colleague using the business information system.

8. A system for providing a collaborative information environment linking a document in a business information system with a scheduled event in an office product, comprising:
a program memory;
a storage device; and
a processor, wherein the processor is adapted to:
(i) generate the document in the business information system, wherein the document contains specific information relevant to an activity of a first colleague;
(ii) create the scheduled event for the first colleague in the office product, wherein the scheduled event is a function of the activity of the first colleague;
(iii) include a link in the scheduled event for the first colleague, wherein the link is a software call to the document in the business information system;
(iv) assign the scheduled event to a second colleague; and
(v) provide the document to the second colleague as a function of the assigned scheduled event and the included link.

9. A computer readable medium including instructions adapted to execute a method for providing a collaborative information environment linking a document in a business information system with a scheduled event in an office product, the method comprising:
generating the document in the business information system, wherein the document contains specific information relevant to an activity of a first colleague;
creating the scheduled event for the first colleague in the office product, wherein the scheduled event is a function of the activity of the first colleague;
including a link in the scheduled event for the first colleague, wherein the link is a software call to the document in the business information system;
assigning the scheduled event to a second colleague; and
providing the document to the second colleague as a function of the assigned scheduled event and the included link.
